(19) United States
(12) Patent Application Publication
(10) Pub. No.: US 2015/0024103 A1
(43) Pub. Date: Jan. 22, 2015

(54) DEVICE AND METHOD FOR PRODUCING MILK FOAM AND/OR WARMED MILK

(71) Applicant: DELICA AG, Birsfelden (CH)

(72) Inventors: Markus Bronnimann, Hermrigen (CH); Roland Affolter, Moriken-Wildegg (CH); Mark Anderson, Thalwil (CH)

(21) Appl. No.: 14/383,252

(22) PCT Filed: Mar. 4, 2013
(86) PCT No.: PCT/EP2013/054277

§ 371 Date: Sep. 5, 2014

(30) Foreign Application Priority Data
Mar. 6, 2012 (EP) 12158249.8

(51) Int. Cl. A47J 31/44; A23C 9/00

(52) U.S. Cl. CPC A47J 31/4485; A23C 9/00
USPC 426/474; 99/453; 99/290

(57) ABSTRACT

The invention relates to a claimed device (1) for producing milk foam and/or warmed milk, comprising a steam supply line (2) that has a steam supply opening (3), said steam supply (2) comprising a tapering first nozzle (4) for obtaining a suction effect in order to suck in milk at a suction opening (5) which is arranged in said first nozzle (4). The device (1) additionally comprises an air supply device (8) for supplying air into the steam supply line (2) through an air supply opening (9). Said steam supply line (2) comprises a tapering second nozzle (10) to obtain a suction effect at the air supply opening (9) which is arranged in the second nozzle (10), and the first nozzle (4) is arranged downstream of the second nozzle (10) with regard to the steam flow direction.

The invention relates to a device and a method for producing milk foam and/or warmed milk according to the preamble of the independent claims.

A device of this type can be used for example to produce milk foam or also warmed milk for coffee beverages, such as cappuccino or latte macchiato. The device can be formed for example as a stand-alone machine or as part of an arrangement comprising a coffee machine.

Devices and methods for producing milk foam or also warmed milk have been known from the prior art for a relatively long period of time. A device of this type for producing milk foam is described for example in WO 2010/100170. This document discloses a device for producing milk foam comprising a steam generator, which is connected to a steam line. A nozzle that tapers and then widens again is arranged in this steam line, such that milk can be sucked in from a milk container. In addition, air is conveyed into the steam line by means of an air pump, and therefore a milk foam is formed by means of the steam/air mixture and the sucked-in milk.

In order to keep the quality of the generated milk foam as constant as possible, there is a need to avoid fluctuations of the ratio of quantity of steam to quantity of supplied air when the quantity of supplied steam is varied, however this cannot always be ensured when using a pump having a substantially constant pump output. This thus results in a fluctuation of the properties of the generated milk foam, and in some circumstances even in an unstable behavior of the device during the production of milk foam.

The object of the present invention is therefore to avoid the disadvantages of the known devices and methods and in particular to create a device of the type mentioned in the introduction, with which the air supply for the milk foam generation can be varied easily and an increased stability of the milk foam generation is achieved in the event of inadvertent fluctuations of individual operating parameters.

These objects are achieved in accordance with the invention with a device and a method having the features of the independent claims.

The device according to the invention for producing milk foam and/or warmed milk comprises a steam supply line having a steam supply opening. The steam supply line has a tapering first nozzle for obtaining a suction effect in order to suck in milk at a suction opening arranged in the first nozzle. The steam is generated in particular by means of a steam generator, which in particular can be controlled. The device further comprises an air supply arrangement for supplying air into the steam supply line through an air supply opening. The steam supply line has a tapering second nozzle for obtaining a suction effect at the air supply opening arranged in the second nozzle. The air supply opening is thus arranged in other words in the region of the second nozzle. The first nozzle is arranged downstream of the second nozzle with regard the steam flow direction.

During operation, steam is thus generated for example by means of a steam generator, which in particular can be controlled, and is conveyed into the steam supply line through the steam supply opening. This steam supply line has a first nozzle with a suction opening in order to suck in milk. In addition, the steam supply line has a second nozzle with an air supply opening, which is fluidically connected to an air supply arrangement in order to supply air into the steam supply line through the air supply opening. The second nozzle is configured such that a suction effect is obtained at the air supply opening in order to supply air, in particular in order to assist the supply of air through the air supply arrangement.

In particular, the first nozzle has a milk supply channel, which leads into the suction opening arranged in a first nozzle channel of the first nozzle. In the context of the present application, the first nozzle channel of the first nozzle is understood to mean the channel of the first nozzle through which, with intended use, the steam or the steam/air mixture is conveyed, in particular in order to suck in milk.

A tapering nozzle in the context of the present application is understood to mean a portion of the steam supply line that has a smaller cross section than the steam supply line arranged upstream of the nozzle, wherein a negative pressure forms in and/or after the tapering cross section and generates the suction effect. The nozzle is advantageously widened again downstream of the narrowest point of the tapering nozzle, in particular to the cross section of the steam supply line upstream of the tapering nozzle. The tapering nozzle can be formed for example as a portion of the steam supply line or can be detachably connected to the steam supply line.

In the context of the present application, an air supply arrangement is understood to mean an arrangement, which in particular can be controlled and/or regulated, for the, in particular active and/or passive, supply of air into the steam supply line. By way of example, the air supply arrangement may be an air pump, in particular a diaphragm pump or also a compressed air pump. The air pump can be controllable and/or regulatable. Alternatively, the air supply arrangement may comprise a controllable and/or regulatable valve, and therefore air can be sucked into the steam supply line in variable quantity by the generated suction effect depending on the valve position. Again alternatively, the air supply arrangement can be formed at an opening that is open to the surrounding environment. The air pump and/or the valve is/are connectable to the air supply opening into the steam supply line, for example by means of a tube, a pipe, a channel or valves, or is/are also connectable directly to the air supply opening. The opening that is open to the surrounding environment is connectable to the air supply opening, for example by means of a tube, a pipe or a channel.

In particular, the use of a pump for air supply has the advantage that the temperature and/or the quantity of the milk foam is/are controllable and/or regulatable. The use of a pump for air supply also allows a time-dependent air supply, such that, for example depending on the beverage to be produced, such as latte macchiato, warmed milk can be produced first, and milk foam can then be produced.

A further advantage of the use of a pump for air supply is the possible minimization or also prevention of a return of warmed milk or milk foam into the second nozzle once the steam supply has been switched off, which could lead to a soiling of parts of the device that are difficult to access, which makes the cleaning difficult. By way of example, it is thus possible to prevent the formation of a negative pressure upstream of the first nozzle as a result of condensing steam, and also to prevent a steam/air mixture from being conveyed with milk upstream, since the air can also continue to be supplied even once the steam supply has been switched off. The warmed milk and/or the milk foam still located in the device can thus be conveyed from the device.

The supply of air by means of an air supply arrangement into the steam supply line in the region of the second nozzle has the advantage that the air supply is assisted by the suction effect generated in the nozzle, whereby, for example, the use of more favorable pumps with lower pump output is possible. In addition, this embodiment of the device leads to the advantageous effect that, in the event of fluctuations for example of the supplied volume flow rate of steam, the suction effect through the second nozzle varies and therefore the ratio of quantity of steam to quantity of air in the steam/air mixture is homogenized and therefore also the quantity of sucked-in milk. The quality of the generated milk foam is thus homogenized, that is to say fluctuations in the foam quality are minimized.

The arrangement of the second nozzle upstream of the first nozzle has the advantage that a fluctuation of the volume flow rate of the steam first leads to a corresponding adaptation of the supplied quantity of air, wherein the quantity of sucked-in milk in the first nozzle is thus likewise varied accordingly by the steam/air mixture, and therefore the ratio between quantity of steam, quantity of air and quantity of milk in the mixture remains substantially constant. The variability of the quality of the generated milk foam is thus reduced.

The first nozzle at the narrowest point preferably has a cross section perpendicular to the steam flow direction greater than the second nozzle at the narrowest point. In particular, the first nozzle has a larger diameter than the second nozzle at the narrowest point.

This has the advantage of a further increased stability of the milk foam generation, which leads to an improved quality of the generated milk foam. The increased stability can be achieved advantageously by the cost-effective structural embodiment of the dimensional ratios of the cross sections, this embodiment functioning reliably during operation.

In particular, the ratio of the diameter of the second nozzle and of the first nozzle at the narrowest point lies in the range from 0.85 to 0.95, preferably in the range from 0.891 to 0.901, preferably at approximately 0.896.

In particular, the first nozzle in the region of its narrowest point has a diameter between 0.5 and 2.5 mm, preferably between 1.25 mm and 1.65 mm, preferably approximately 1.45 mm.

In addition, the second nozzle in the region of its narrowest point in particular has a diameter between 0.5 and 2.4 mm, preferably between 1.1 mm and 1.5 mm, preferably approximately 1.3 mm.

In addition, it is expedient if the milk supply line to the first nozzle has a cross section between 0.5 and 2.5 mm², preferably approximately 1.25 mm². It is additionally expedient if the first nozzle has an outflow diameter between 2 and 15 mm, preferably approximately 6 mm to 8 mm. A good foam distribution is thus ensured, irrespective of the cup size.

The air supply into the steam supply line is implemented particularly advantageously via a slotted air supply opening, preferably having a width of the slot between 0.2 mm and 2 mm, preferably approximately 0.5 mm. This air supply opening may also have any other geometric shape.

The milk supply into the steam supply line, in particular for the milk foam production, is implemented particularly advantageously via a suction opening that is circular in particular, preferably having a cross section between 0.19 mm² and 5 mm², preferably between 1.3 mm² and 2.2 mm² and particularly preferably from approximately 1.5 mm² to 2.1 mm². A circular suction opening accordingly has a diameter between 0.5 mm and 2.5 mm, preferably approximately 1.4 mm to 1.6 mm. This suction opening may also have any other geometric shape.

When a steam/air mixture having a substantially constant volume flow rate is supplied, the first nozzle suitable for producing warmed milk preferably has a suction opening with a cross section smaller than a first nozzle suitable for producing milk foam. In particular, the suction opening has a cross section between 0.19 mm² and 5 mm², preferably between 0.75 mm² and 1.15 mm² and particularly preferably of approximately 0.95 mm². A circular suction opening accordingly has a diameter between 0.5 mm and 2.5 mm, preferably approximately 1.1 mm.

This has the advantage that, for example, a nozzle suitable for producing milk foam can be exchanged with a nozzle suitable for producing warmed milk, which can be easily handled and leads to a more stable behavior of the device when producing milk foam or when producing warmed milk.

The embodiment of the suction opening of the first nozzle for producing warmed milk when a steam/air mixture with substantially constant volume flow rate is supplied can be ascertained by a person skilled in the art on the basis of routine tests, starting from a nozzle suitable for producing milk foam, since the suction opening suitable for producing warmed milk has a smaller cross section of the suction opening.

In particular, the first nozzle has a suction opening with a variable cross section of the suction opening. The cross section at the first nozzle is preferably adjustable, in particular in a range from 0.19 mm² and 5 mm² and preferably from 0.75 mm² and 2.1 mm².

The adjustability of the cross section of the suction opening can be obtained for example by means of an adjustable aperture, which is arranged in the suction opening. Alternatively to the aperture, a slide or other means known to a person skilled in the art can also be used.

The air supply arrangement particularly preferably comprises an air pump, which in particular is formed as a diaphragm air pump. This air pump in particular has a variable pump output.

This has the advantage that, by varying the pump output, the quantity of air supplied into the steam supply line is varied, which leads to a change of the consistency or quality of the milk foam. It is thus possible to easily adapt the properties of the milk foam and/or of the warmed milk to the requirements of the corresponding beverage.

The air supply arrangement particularly preferably comprises a controllable and/or regulatable valve for varying the quantity of air that can be supplied.

This has the advantage that the air is sucked in due to the suction effect generated in the second nozzle and the quantity of air conveyed into the steam supply line can be controlled and/or regulated by the position of the valve. This leads to a cost-effective embodiment of the device with low energy consumption.

It is also conceivable to use an air supply arrangement comprising an air pump and a controllable and/or regulatable valve. This gives the possibility of the flexible adjustment of the supplied quantity of air by varying the pump output of the air pump and by adjusting the valve.

The suction opening is preferably arranged substantially in the region of the narrowest point of the first nozzle.

This has the advantage that the generated suction effect is greatest in this region and therefore a greater quantity of milk can be sucked in, which inter alia may thus have a higher speed in the steam supply line, whereby improved mixing is ensured under certain circumstances.

The term “region of the narrowest point of a nozzle” in the context of the present application is understood to mean a region along the nozzle channel in which a negative pressure sufficient for generating the suction effect for milk and/or air can be achieved. In particular, the region of the narrowest point of a nozzle comprises the region with the narrowest cross section of the nozzle and additionally, upstream and downstream, three times the smallest expansion perpendicular to the flow generating the suction effect, preferably twice the smallest expansion, and particularly preferably the smallest expansion. In particular, this region is determined in the flow direction of the steam from the starting point and end point of the narrowest point along the axis of the nozzle channel. By way of example, the smallest expansion in the case of a channel that is circular in cross section is the smallest diameter d; three times the smallest expansion is three times the diameter; the region of the narrowest point of the nozzle comprises three times the diameter upstream and three times the diameter downstream, calculated from the starting point and end point of the narrowest point of the nozzle channel along the axis of the nozzle channel; overall, the region of the narrowest point of the nozzle along the axis of the nozzle channel has six times the diameter of the narrowest point of the nozzle channel plus the region with the narrowest cross section of the nozzle along the axis of the nozzle channel.

A milk supply line is quite particularly preferably connectable to the first nozzle in such a way that milk from a milk container can be sucked into the first nozzle through the suction opening by means of the suction effect.

This has the advantage that, for example, separate milk containers can also be connected by means of the milk supply line to the first nozzle, which makes the device more versatile and user-friendlier.

The air supply opening is preferably arranged substantially in the region of the narrowest point of the second nozzle.

This has the advantage that the suction effect is strongest in the region of the narrowest point of the second nozzle and therefore the quantity of air sucked in is also greatest, whereby in particular the assistance of the supply of air through the air supply arrangement is improved. In addition, the adaptation of the air conveyed into the steam supply line by means of the suction effect is thus improved depending on the potentially varying volume flow rate of steam.

The air supply arrangement is particularly preferably formed as an opening that is open to the surrounding environment. In other words, no control means for varying the volume flow rate of air are provided.

This has the advantage of a structurally simpler and cost-effective air supply arrangement.

In particular, the second nozzle has an air supply channel, which leads into a second nozzle channel of the second nozzle at the position of the air supply opening. The air supply channel and the second nozzle channel are in particular arranged substantially perpendicular to one another.

This embodiment has the same advantage as above in respect of the arrangement of the milk supply channel in the first nozzle channel.

The second nozzle channel of the second nozzle is understood in the context of the present application to mean the channel of the second nozzle through which, with intended use, the steam is conveyed.

The first nozzle and/or the second nozzle is/are quite particularly preferably formed as a Venturi nozzle.

This has the advantage that Venturi nozzles of this type are reliable in operation and therefore lead to a low variation of the quality of the generated milk foam.

The device is preferably divided into two parts, specifically into a stationary apparatus component containing at least the air supply arrangement, the second nozzle and air supply opening, and into a mobile component containing the first nozzle. The mobile component is detachably connected to the steam supply line exiting from the device component.

The terms “stationary” and “mobile” in the context of the present application mean that the mobile component can be detached from the apparatus component, for example for cleaning purposes, and reinstated, whereas the stationary apparatus component can always have the same location. Of course, the stationary apparatus component may be movable in the sense that the stationary apparatus component is transportable.

The term “milk supply line” in the context of the present application is understood to mean any rigid or flexible line, irrespective of its length, that leads into the first nozzle.

The device particularly preferably has control means, via which the air supply arrangement and/or the steam generator can be controlled. The mixing ratio of the steam/air mixture in the steam supply line can be predefined or adjusted.

In the context of the present application, a “control means” is understood to mean an arrangement for varying the volume flow rate conveyed into the steam supply line and/or for varying the volume flow of air conveyed into the steam supply line. This control means, for example, may contain microprocessors and may be formed for example as a control computer, which for example is integrated in a coffee machine or a milk frother and/or is connected thereto. The composition of the steam/air mixture can thus be varied easily, whereby different milk or coffee/milk beverages can be produced. In addition, the air supply arrangement can be activated by the control means in such a way that merely hot milk or warmed milk is produced, which can be achieved by a reduced air supply or an intermittent air supply.

The device quite particularly preferably has storage means for storing at least one operating parameter for at least two milk treatment types which can be used by the control means. In particular, operating parameters such as steam temperature, moisture content of the steam, volume flow rate of the steam, pump output of the air supply arrangement, pump output of the water pump, heating capacity of the steam heater or any combinations thereof can be stored.

A storage means of this type can contain microprocessors for example and can be formed as a computer. In particular, the control means and storage means may be formed as a module, which additionally comprises control elements in order to select the corresponding operating parameters and/or the milk or coffee beverage to be produced.

This has the advantage that, depending on the requirements of the beverage to be produced, the type of milk foam to be produced can be selected for example by stored operating parameters, which simplifies the operation.

The device preferably has a temperature sensor for determining the steam temperature prior to the conveyance of the steam into the steam supply line. In particular, the temperature sensor is arranged in the steam generator. In addition, the steam generator is in particular controllable and/or regulatable depending on the determined steam temperature.

This has the advantage that the steam temperature can be monitored and a substantially optimal steam temperature can be ensured for milk foam generation or the production of warmed milk.

In particular, the temperature sensor is formed as a thermistor, preferably as a negative temperature coefficient thermistor, that is to say as an NTC thermistor.

The device particularly preferably comprises a pressure sensor for determining the steam pressure prior to the conveyance of the steam into the steam supply line.

This has the advantage that the steam pressure can be monitored and a substantially optimal pressure can be ensured for milk foam generation or the production of warmed milk.

By measuring the parameters constituted by pressure and/or temperature of the steam prior to the conveyance of the steam into the steam supply line and by adjusting these parameters in the steam generator, substantially dry steam, that is to say overheated steam, can advantageously be conveyed into the steam supply line, which leads to an improved quality of the milk foam and to an improved stability of the milk foam generation.

The device quite particularly preferably has a controllable and/or regulatable valve, in particular a solenoid valve, which opens a fluidic connection from the steam generator into the steam supply line depending on pressure and/or temperature of the steam.

This has the advantage of ensuring that the steam conveyed into the steam supply line has the required temperature and the required pressure.

The device preferably has a safety valve, in particular a pressure relief valve, which is formed in such a way that, when steam having a pressure above a pre-set and/or adjustable threshold value is supplied, the steam is diverted in particular into a collection container, for example a condenser. In other words, the steam is not conveyed into the steam supply line when the pressure is greater than or equal to the threshold value.

In particular, the pressure relief valve is formed as a mechanical pressure relief valve.

This has the advantage of ensuring that, in the event of an overpressure occurring in the device, the steam at overpressure can be diverted and substantially is not conveyed into the steam supply line, which increases the safety and stability of the device.

In particular, the overpressure valve is arranged upstream of the controllable and/or regulatable valve, which opens a fluidic connection from the steam generator into the steam supply line depending on pressure and/or temperature of the steam.

This has the advantage of a simplified and stable control and/or regulation of the device in order to ensure that substantially dry steam is conveyed into the steam supply line.

This advantage can be achieved for example in that, in a first step, steam is generated in the steam generator by heating water, whilst the valve is closed; an overpressure thus builds up in the device, such that the pressure relief valve opens and steam is diverted; by continued heating in the steam generator, the steam reaches a pre-set and/or adjustable temperature threshold value; once the temperature threshold value has been reached, the valve is opened, such that the pressure in the device drops; the pressure relief valve closes and steam with the desired temperature is conveyed into the steam supply line in order to produce milk foam or warmed milk.

A portion of the first nozzle channel of the first nozzle along the nozzle channel, which portion at least comprises the region of the suction opening, is particularly preferably arranged eccentrically relative to the nozzle channel upstream and/or downstream of said portion.

This has the advantage of improved and more stable milk production. By way of example, large bubbles may form in the region where milk is sucked in, which may lead to a reduction of the milk sucked in and therefore to a milk foam of poorer quality and/or to a more unstable behavior of the device during milk foam production; this can be avoided advantageously by means of the eccentric embodiment.

The embodiment of a nozzle for milk suction with a portion arranged eccentrically, in portions, relative to the nozzle channel upstream and/or downstream of said portion may also be used advantageously in milk frothers from the prior art; for example, the use of the nozzle for milk suction with a portion arranged eccentrically, in portions, with a milk frother according to WO 2010/100170 A1 is conceivable.

An “eccentric arrangement of a portion relative to the nozzle channel upstream and/or downstream of said portion” is understood in the context of the invention to mean that the longitudinal axis of the portion perpendicular to the middle flow direction is offset relative to the longitudinal axis of the nozzle channel upstream and/or downstream of said portion.

The eccentricity is preferably designed such that the steam supply channel upstream of the suction opening transitions in portions in the peripheral direction on the inner wall without a step into the eccentrically arranged portion, in particular into the first nozzle channel. In other words, the steam supply channel upstream of the suction opening and the first nozzle are configured such that the inner wall runs in a portion in the peripheral direction without a step along the flow direction.

The “inner wall” is understood to mean the wall of the steam supply line and of the first nozzle which is in contact with the steam/air mixture and/or the milk with intended use.

The “peripheral direction” in the context of the present application is understood to mean the direction that is arranged substantially perpendicular to the middle flow direction. By way of example, the inner wall in the peripheral direction thus has no step in a first portion and has a step in a second portion.

This has the advantage that, due to the embodiment of the inner wall in portions without a step, the flow is swirled to a lesser extent and the milk foam production is thus improved and made more stable.

A further aspect of the present invention is directed to a milk frother comprising a device as described above.

A milk frother of this type is formed as a stand-alone apparatus or, for example, in a manner connectable to a coffee machine and, in addition to the device, has a housing for the device and also a corresponding flow supply, inter alia.

An additional aspect of the present invention is directed to a coffee machine comprising a device as described above and/or a milk frother as described beforehand.

A further aspect of the present invention is directed to a method for producing milk foam by means of a device as described above. This method comprises the step of generating a steam flow by means of a steam generator. The steam is then conveyed through a steam supply opening into a steam supply line. Before and/or after the previous step, air is fed into the steam supply line through an air supply opening into a tapering second nozzle, in such a way that a flow with substantially constant ratio of steam volume to air volume is produced. Milk is then sucked in from a milk container in a tapering first nozzle, which is fluidically connected by means of a milk supply line to the milk container. The milk is sucked in by means of the supplied flow. Milk foam is then produced.

An additional aspect of the present invention is directed to a method for producing warmed milk by means of a device as described above. In a first step, a steam flow is generated by means of a steam generator. The steam is then conveyed through the steam supply opening into the steam supply line. Before and/or after the previous step, air is supplied into the steam supply line through an air supply opening into a tapering second nozzle with pulsed volume flow rate. Milk is then sucked in from a milk container in a tapering first nozzle, which is fluidically connected by means of a milk supply line to the milk container. The milk is sucked in by means of the supplied pulsed volume flow rate. Warmed milk is then produced.

The term “pulsed” in the context of the present application is understood to mean an intermittent air supply and/or an air supply that is variable over time in terms of the volume flow rate, with a frequency of at least 1 Hz, preferably of at least 5 Hz, and particularly preferably of at least 10 Hz. The variation of the volume flow rate of the supplied air between minimum and maximum based on the maximum is at least 25%, preferably at least 50% and particularly preferably at least 75%.

A further aspect of the present invention is directed to a method for producing warmed milk, in particular with a device for producing warmed milk as described above. This method comprises the step of generating a steam flow by means of a steam generator. The steam is then conveyed through a steam supply opening into a steam supply line. Before and/or after the previous step, air is supplied into the steam supply line through an air supply opening into a tapering second nozzle, in such a way that a flow with substantially constant ratio of steam volume to air volume is produced. Milk is then sucked in from a milk container in a tapering first nozzle, which is fluidically connected by means of a milk supply line to the milk container. The milk is sucked in by means of the supplied flow. Warmed milk is then produced. The first nozzle suitable for producing warmed milk has a suction opening with a cross section smaller than a first nozzle suitable for producing milk foam. In particular, the suction opening has a cross section between 0.19 mm² and 5 mm², preferably between 0.75 mm² and 1.15 mm², and particularly preferably of approximately 0.95 mm²; a circular suction opening accordingly has a diameter between 0.5 mm and 2.5 mm, preferably approximately 1.1 mm.

This has the advantage of a method for producing warmed milk that is of structurally simple design and that functions reliably and in a stable manner during operation. In particular, there is no need for an additional controller, for example for generating a pulsed flow comprising a mixture of air and steam, which makes the device more cost-effective in terms of production.

A further aspect concerns a kit for use with a stationary apparatus component, which comprises a second nozzle, for forming a device for producing milk foam and/or warmed milk, in particular for use in a method as described above. The kit comprises at least one first mobile component containing a first nozzle with a cross section of a suction opening for sucking in milk and a second mobile component containing a further first nozzle with a cross section of a suction opening for sucking in milk. In particular, at least one and preferably both suction openings of the first and second mobile component is/are arranged substantially in the region of the narrowest point of the respective nozzle. The suction opening of the first mobile component has a cross section suitable for producing milk foam when a steam/air mixture with substantially constant volume flow rate is supplied. The suction opening of the second mobile component has a cross section suitable for producing warmed milk when a steam/air mixture with substantially constant volume flow rate is supplied. The cross section of the suction opening of the second mobile component is smaller than the cross section of the suction opening of the first mobile component.

This has the advantage that, by means of an exchange of the mobile components of the kit on the stationary apparatus component and supply of a flow with substantially constant ratio of steam volume to air volume, either milk foam or warmed milk can be produced reliably, without the need for further interventions by an operator during operation.

The suction opening of the first mobile component preferably has a cross section between 0.19 mm² and 5 mm², preferably between 1.3 mm² and 2.2 mm² and particularly preferably from approximately 1.5 mm² to 2.1 mm²; a circular suction opening of the first mobile component accordingly has a diameter between 0.5 mm and 2.5 mm, preferably approximately 1.4 mm to 1.6 mm; the suction opening of the second mobile component preferably has a cross section between 0.19 mm² and 5 mm², preferably between 0.75 mm² and 1.15 mm² and particularly preferably of approximately 0.95 mm²; a circular suction opening of the second mobile component accordingly has a diameter between 0.5 mm and 2.5 mm, preferably approximately 1.1 mm; the cross section of the suction opening of the second mobile component is selected such that this is smaller than the cross section of the suction opening of the first mobile component.

Further features and advantages of the invention will emerge from the following description of the exemplary embodiments and from the drawings, in which:

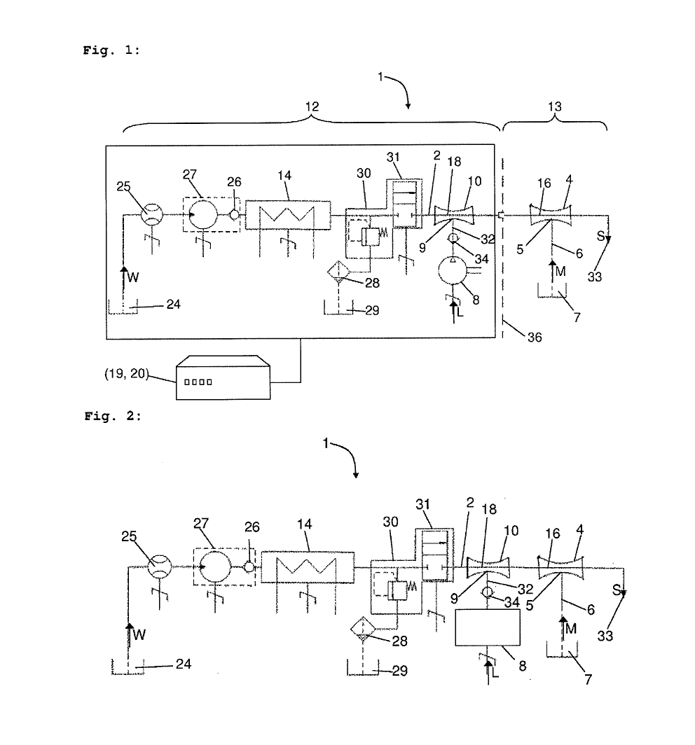

FIG. 1: shows a schematic illustration of a device according to the invention with mobile component and stationary apparatus component;

FIG. 2: shows a schematic illustration of a device according to the invention according to FIG. 1 without division into a mobile component and a stationary apparatus component;

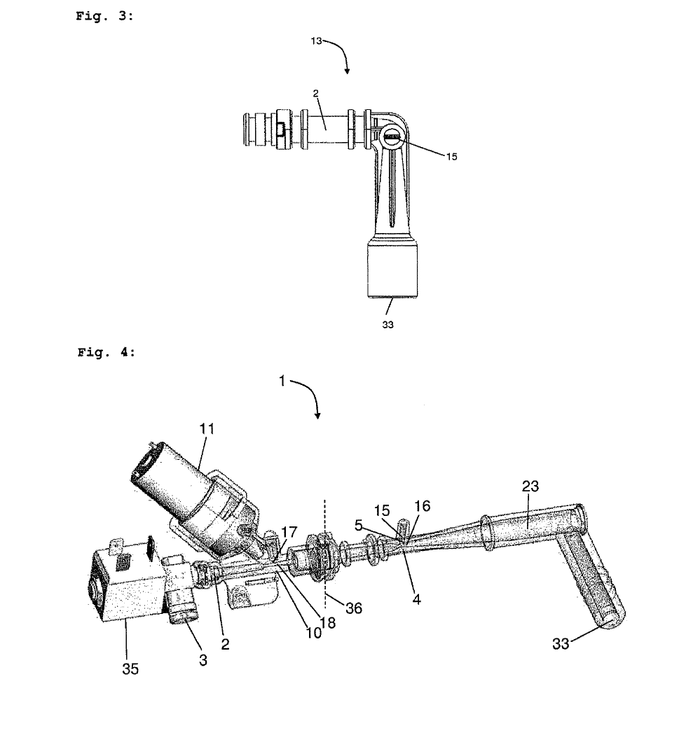

FIG. 3: shows a side view of a mobile component of a device according to the invention with a milk supply channel arranged in a bend;

FIG. 4: shows a perspective illustration of a partial detail of the device according to the invention according to FIG. 1;

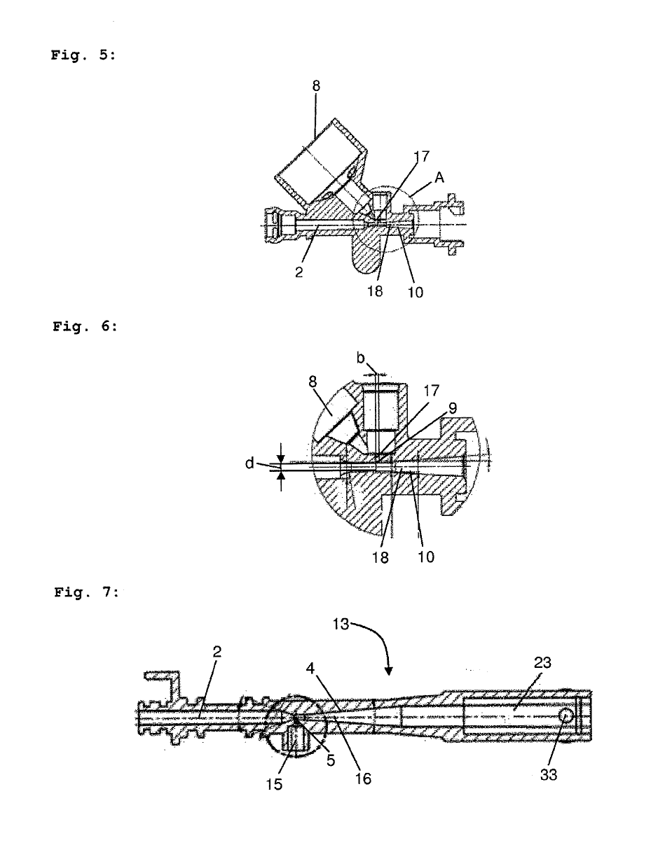

FIG. 5: shows a sectional illustration of the region of the air supply according to FIG. 4;

FIG. 6: shows the detail A of the air supply according to FIG. 5;

FIG. 7: shows a sectional illustration of the mobile component of the device according to the invention;

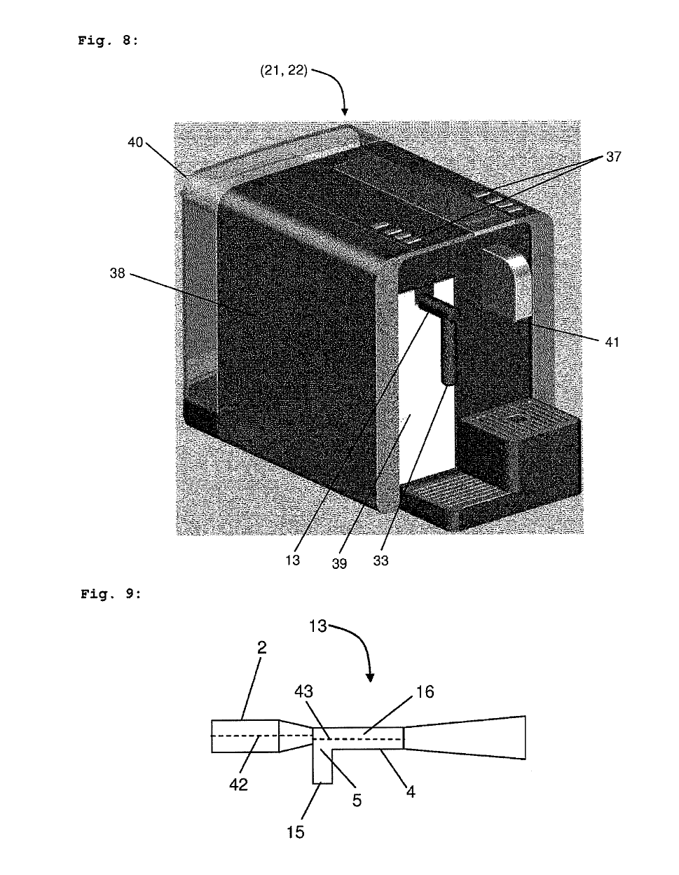

FIG. 8: shows a perspective illustration of a milk frother according to the invention and of a coffee machine;

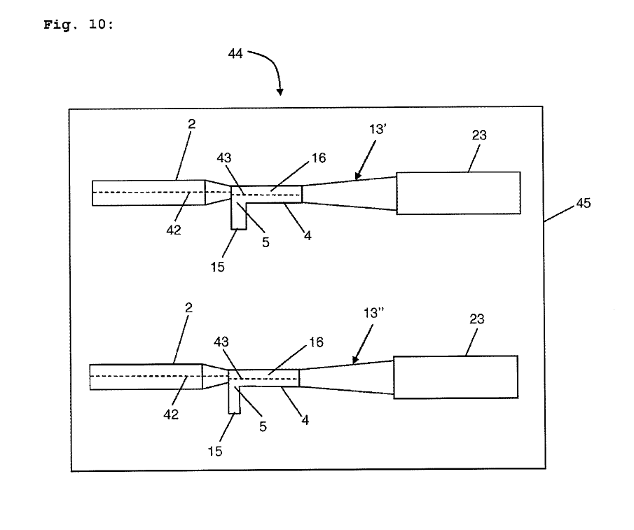

FIG. 9: shows an enlarged schematic illustration of a detail of the mobile component according to FIG. 7;

FIG. 10: shows a schematic illustration of a kit according to the invention comprising two nozzles.

FIG. 1 shows a schematic illustration of a device 1 according to the invention for producing milk foam and/or warmed milk, from which the fundamental structure and operating principle of the device 1 are clear. By means of a water pump 27, water W is removed from a water container 24, wherein a flowmeter 25 is operatively connected to the water pump by means of the control means 19 for control and regulation. Reference sign 26 denotes a check valve. To produce steam, the removed water, of which the flow direction is indicated by the arrow, is guided through the steam generator 14. In the case of an overpressure, steam can be diverted by means of the pressure relief valve 30 instead of being guided into the steam supply line 2. The pressure relief valve 30 thus functions as a mechanical pressure sensor. By means of the condenser 28, the steam diverted via the pressure relief valve 30 can be condensed and excess residual water can be collected in the residue tray 29. It is possible to control and/or regulate the water pump 27 by means of the flowmeter 25 in order to adjust the quantity of conveyed water. The quantity of steam can be adjusted hereby.

A 2/2 valve 31 is arranged in the steam supply line 2, into which the water vapor is conveyed.

To generate water vapor, water or also a water/steam mixture is heated in the steam generator 14 whilst the 2/2 valve 31 is closed, such that no water vapor is conveyed into the steam supply line 2. A pressure thus builds in the device 1. When the pressure reaches a threshold value of approximately 2.5 bar, the pressure relief valve 30 opens, such that steam is guided to the condenser 28. The heating of the water/steam mixture in the steam generator 14 is continued. When the temperature in the steam generator 14, which is measured by means of a temperature sensor (not illustrated) arranged in the steam generator 14, reaches a temperature threshold value, the 2/2 valve 31 is opened, whereby the pressure in the device drops and the pressure relief valve 30 is closed. The steam thus reaches the desired temperature and the desired pressure for the production of milk foam or warmed milk.

A second nozzle 10 with a second nozzle channel 18 is arranged downstream in relation to the 2/2 valve, and an air supply opening 9 leads into said second nozzle in the region of the narrowest point. Air L can be conveyed via this air supply opening 9 by means of the air supply arrangement 8, which is formed as a diaphragm pump, along the indicated arrow through the air supply line 32 into the second nozzle channel. To protect the diaphragm pump, a membrane valve 34 is arranged between the air supply arrangement 8 and the second nozzle 10.

The air conveyed into the second nozzle 10 by means of the air supply arrangement 8 mixes with the water vapor in the second nozzle 10. The pump output of the air supply arrangement 8 is assisted by the suction effect generated in the second nozzle 10 by the flow of the water vapor along the second nozzle channel 18.

A first nozzle 4 with a first nozzle channel 16 is arranged downstream of the second nozzle 10. A suction opening 5 with a diameter of 1.6 mm is arranged in the region of the narrowest point of the first nozzle 4, and a milk supply line 6 is connected to said suction opening. This milk supply line 6 is fluidically connected to a milk container 7, wherein milk M is sucked into the first nozzle in accordance with the indicated arrow by the suction effect in the first nozzle 4. The milk M is thus mixed with the mixture of water vapor and air, such that foam S forms, which is conveyed from the outlet 33 from the device 1 in accordance with the indicated arrow.

To control and/or regulate the device 1, the stationary apparatus component 12 is operatively connected to the control means 19 and a storage means 20 for control and regulation, for example in order to control or regulate the water pump 27, the steam generator 14, the 2/2 valve 31 or also the air supply arrangement 8. By way of example, operating parameters in the device 1 can be selected such that either milk foam or warmed milk is conveyed from the outlet 33.

A mobile component 13 comprising at least the first nozzle 4 and the outlet 33 is detachably connected to the stationary apparatus component 12, which facilitates the cleaning of the device, since, with intended use, merely the mobile component 13 comes into contact with milk and is to be cleaned accordingly. The separation between stationary apparatus component 12 and mobile component 13 is indicated by the separating line 36.

During operation, in order to produce milk foam, air is supplied to the second nozzle 10 in such a way that a flow with substantially constant ratio of steam volume to air volume is generated. In the first nozzle 4, milk is sucked in by the flowing steam/air mixture and mixed with the steam/air mixture. In a mixing chamber (not shown here), which constitutes a widening of the steam supply line 2, a relaxation occurs, that is to say a pressure reduction, whereby the milk foam is produced and then leaves the device 1 through the outlet 33.

To produce warm milk, a steam flow is conveyed into the steam supply line 2, as is also the case with the production of milk foam. However, in contrast to the production of milk foam, air is supplied in a pulsed manner by means of the air supply arrangement 8. In the first nozzle 4, a smaller quantity of milk is sucked in as a result, whereby less milk foam and primarily warmed milk is produced, which leaves the device 1 through the outlet 33.

To produce warm milk, as an alternative to the pulsed supply of air, air can also be supplied in such a way that a flow with substantially constant ratio of steam volume to air volume is generated. To this end, a diameter of the suction opening 5 of 1.1 mm is selected, in contrast to the above embodiment with a diameter of the suction opening 5 of 1.4 mm.

To clean the device 1, water is supplied by means of the water pump 27 from the water container 24 to the steam generator 14, wherein the heating capacity of the steam generator is reduced, such that no steam formation takes place, but merely warmed water is generated. The flow rate of the water is set by means of the water pump 27, such that the first nozzle 4 is cleaned without water being able to reach through the suction opening 5 into the milk supply line 6 and thus into the milk container 7. The first nozzle 4 is thus cleaned substantially of milk residues.

From hereon and hereinafter, like features will be denoted by like reference signs.

FIG. 2 schematically illustrates a device 1 according to the invention as illustrated in FIG. 1. In contrast to FIG. 1, there is no separation in the device according to FIG. 2 into a stationary apparatus component and a mobile component. In addition, the air supply arrangement 8 is formed in the present case as a solenoid valve. This can be opened and closed, whereby the airflow L into the second nozzle 10 can be controlled or regulated using a control means not shown here.

FIG. 3 shows a side view of a mobile component 13, which has a bend of approximately 90°. A milk supply channel 15, which for example can be connected to a milk supply line, is arranged in the region of the bend.

FIG. 4 illustrates a perspective illustration of a partial detail of the device 1. The steam produced in the steam generator (not shown here) is conveyed into the steam supply line 2 via a steam supply opening 3. Air is conveyed into the second nozzle by means of the air pump 11, which functions here as an air supply arrangement, via an air supply channel 17, which is arranged substantially perpendicularly to the second nozzle channel 18, whereby a steam/air mixture is formed. This steam/air mixture is then conveyed into the first nozzle 4 with the suction opening 5, wherein a milk supply channel 15 is connected to the suction opening 5. For example, a milk supply line can be connected to this milk supply channel 15. The steam/air/milk mixture is conveyed into a mixing chamber 23 downstream of the first nozzle 4, which mixing chamber has greater expansion perpendicularly to the middle flow direction than the channel arranged upstream, whereby a relaxation, that is to say a pressure reduction, is achieved in the steam/air/milk mixture. The foam is then conveyed through the outlet 33 to the mixing chamber 23.

Here, the separation of the device into a stationary apparatus component and a mobile component is indicated by means of the separating line 36.

The steam supply line for the steam supply can be opened or closed by means of a solenoid valve 35 in accordance with the temperature of the steam, which has been determined using a sensor (not illustrated here). The temperature sensor (not illustrated) is arranged in the steam generator.

FIG. 5 illustrates a sectional illustration of a detail of the air supply region according to FIG. 4. Here, the substantially perpendicular arrangement of the air supply channel 17 relative to the second nozzle channel 18 can be better seen.

FIG. 6 illustrates a sectional illustration of the detail A of FIG. 5, wherein the air supply opening 9 can also be better seen here.

The second nozzle channel 18, at the narrowest point, has a minimum diameter d of 1.3 mm. The air supply channel 17 is formed as a slot with a width b of 0.5 mm.

FIG. 7 illustrates a sectional illustration of the mobile component 13, wherein, in this sectional illustration, the substantially perpendicular arrangement of the milk supply channel 15 relative to the first nozzle channel 16 can be better seen. The first nozzle channel 16 has a minimum diameter of 1.45 mm at the narrowest point.

A portion of the first nozzle channel 16 of the first nozzle 4, which comprises the region of the suction opening 5, is arranged eccentrically to the nozzle channel upstream of the portion. This is illustrated in detail in FIG. 9.

FIG. 8 illustrates a perspective illustration of a coffee machine 22 with a milk frother 21 according to the invention. The coffee machine 22 and the milk frother 21 comprising the device according to FIG. 4 are arranged in a common housing 38. Control elements 37 are arranged on the upper side of the housing 38 and can be used for example to select a desired beverage or also a cleaning of the milk frother 21 or of the coffee machine 22.

The coffee machine 22 has a coffee outlet 41 for dispensing a coffee beverage.

A water tank 40 for producing a coffee beverage, for generating steam for the milk beverage or for cleaning the milk frother 21 or the coffee machine 22 is arranged on a rear face of the machine.

A milk tank 39 is accommodated in the machine, wherein the mobile component 13 with the outlet 33 for warmed milk or milk foam is arranged on the milk tank. The mobile component 13 functions as a grip for inserting or removing the milk tank 39 into or from the milk frother 21. The mobile component 13 is mounted rotatably such that the outlet 33 can be positioned for example over a cup, which is positioned below the coffee outlet 41. With appropriate function selection by means of the control elements 37, a beverage such as cappuccino or latte macchiato can thus be produced in an automated manner.

FIG. 9, in an enlarged illustration, schematically shows the region of the first nozzle 4 according to FIG. 7 marked by a circle.

The portion of the first nozzle channel 16 comprising the region of the suction opening 5 has a nozzle channel axis 43, which is arranged eccentrically relative to the steam supply channel 2 with the steam supply line axis 42 upstream of said portion. The steam supply channel 2 transitions upstream of the suction opening 5 in portions in the peripheral direction without a step into the first nozzle channel 16.

FIG. 10, in a schematic illustration, shows a kit 44 according to the invention in a packaging 45, comprising a first mobile component 13′ suitable for the milk foam production and a second mobile component 13″ suitable for the production of warmed milk when a steam/air mixture is supplied with substantially constant volume flow rate. The cross section of the suction opening 5 of the first mobile component 13′ is approximately 1.8 mm² and the cross section of the suction opening 5 of the second mobile component 13″ is approximately 0.95 mm².

1-15. (canceled)

16. A device for producing at least one of milk foam or warmed milk, comprising
a steam supply line having a steam supply opening, wherein the steam supply line has a tapering first nozzle for obtaining a suction effect in order to suck in milk at a suction opening arranged in the first nozzle, wherein the steam can be generated by means of a steam generator,
an air supply arrangement for supplying air into the steam supply line through an air supply opening,
wherein the steam supply line has a tapering second nozzle for obtaining a suction effect at the air supply opening arranged in the second nozzle, wherein the first nozzle is arranged downstream of the second nozzle with regard the steam flow direction.

17. The device as claimed in claim 16, wherein the steem generator can be controlled.

18. The device as claimed in claim 16, wherein the first nozzle at the narrowest point has a cross section perpendicular to the steam flow direction greater than the second nozzle at the narrowest point.

19. The device as claimed in claim 16, wherein the air supply arrangement comprises an air pump.

20. The device as claimed in claim 19, wherein the air pump is diaphragm air pump.

21. The device as claimed in claim 19, wherein the air pump has a variable pump output.

22. The device as claimed in claim 16, wherein the air supply arrangement comprises a controllable and/or regulatable valve for varying the quantity of air that can be supplied.

23. The device as claimed in claim 16, wherein the suction opening is arranged substantially in the region of the narrowest point of the first nozzle and/or the air supply opening is arranged substantially in the region of the narrowest point of the second nozzle.

24. The device as claimed in claim 16, wherein the air supply arrangement is formed as an opening that is open to the surrounding environment.

25. The device as claimed in claim 16, wherein a portion of a first nozzle channel of the first nozzle along the nozzle channel, which comprises at least the region of the suction opening, is arranged eccentrically relative to the nozzle channel upstream and/or downstream of the portion.

26. The device as claimed in claim 16, wherein the second nozzle has an air supply channel, which leads into a second nozzle channel of the second nozzle at the position of the air supply opening, wherein the air supply channel and the second nozzle channel are arranged substantially perpendicular to one another.

27. The device as claimed in claim 16, wherein the device has control means, via which at least one of the air supply arrangement or the steam generator can be controlled to predefine the mixing ratio of the steam/air mixture in the steam supply line.

28. The device as claimed in claim 27, wherein the device has storage means for storing at least one operating parameter for at least two milk treatment types which can be used by the control means.

29. The device as claimed in claim 28, wherein the operating parameter comprises at least one of the steam temperature, the moisture content of the steam, the volume flow rate of the steam, the pump output of the air supply arrangement, the pump output of the water pump, the heating capacity of the steam heater or any combinations thereof.

30. A milk frother comprising a device as claimed in claim 16.

31. A coffee machine comprising at least one of a device as claimed in claim 16 or a milk frother as claimed in claim 30.

32. A method for producing milk foam by means of a device, comprising the following steps:
generating a steam flow by means of a steam generator,
conveying the steam through a steam supply opening into a steam supply line,
supplying air into the steam supply line through an air supply opening into a tapering second nozzle, in such a way that a flow with substantially constant ratio of steam volume to air volume is generated,
sucking in milk from a milk container in a tapering first nozzle, which are fluidically connected to one another by means of a milk supply line, by means of the supplied flow,
producing milk foam.

33. A method for producing warmed milk by means of a device, comprising the following steps:
generating a steam flow by means of a steam generator,
conveying the steam through the steam supply opening into the steam supply line,
supplying air into the steam supply line through an air supply opening into a tapering second nozzle with pulsed volume flow rate,
sucking in milk from a milk container in a tapering first nozzle, which are fluidically connected to one another by means of a milk supply line, by means of the supplied pulsed volume flow rate,
producing warmed milk.

34. A kit for use with a stationary apparatus component, which comprises a second nozzle for forming a device for producing at least one of milk foam or warmed milk as claimed in claim 16, wherein the kit comprises at least one first mobile component containing a first nozzle with a cross section of a suction opening and a second mobile component containing a further first nozzle with a cross section of the suction opening for sucking in milk, wherein the suction opening of the first mobile component has a cross section suitable for producing milk foam when a steam/air mixture with substantially constant volume flow rate is supplied, wherein the suction opening of the second mobile component has a cross section suitable for producing warmed milk when a steam/air mixture with substantially constant volume flow rate is supplied, and wherein the cross section of the suction opening of the second mobile component is smaller than the cross section of the suction opening of the first mobile component.
